(19) United States
(12) Patent Application Publication
(10) Pub. No.: US 2003/0036958 A1
(43) Pub. Date: Feb. 20, 2003

(54) Methods and apparatus for connecting consumers to advertisers

(76) Inventors: James L. Warmus, LaGrange, IL (US); Margaret Jean Lafleur, Oak Park, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/219,017

(22) Filed: Aug. 14, 2002

Related U.S. Application Data
(60) Provisional application No. 60/312,619, filed on Aug. 15, 2001.

(51) Int. Cl. G06F 17/60; H04M 3/42

(52) U.S. Cl. 705/14; 455/414

(57) ABSTRACT

A system for connecting consumers to advertisers using bar-coded yellow page headings and bar-code scanning Internet devices is disclosed. Advertisers register with a server by providing information such as which yellow page headings the advertiser is associated with and how the advertiser is to be contacted. Consumers make requests to the server by scanning yellow page bar-code headings and indicating how the consumer prefers to be contacted. The server then finds matches between consumers and advertisers and facilitates communication between them.

### RELATED APPLICATION

This application claims priority from U.S. provisional patent application Serial No. 60/312,619 filed Aug. 15, 2001.

### TECHNICAL FIELD

The present invention relates in general to Internet communications and, in particular, to methods and apparatus for connecting consumers to advertisers.

### BACKGROUND

Often, consumers use an Internet search engine to locate a business which provides a certain product or service. By entering keywords, selecting hyperlinks, and reading web pages, a consumer may select one or more such businesses in his area. In addition, the consumer may fill out a short form to indicate he would like someone from the business to contact him/her at a certain phone number or e-mail address.

However, when the consumer is using a web enabled wireless telephone, entering keywords, selecting hyperlinks, reading web pages, and filling out forms is cumbersome due to the limited user interface features of most portable electronic devices. In addition, entering the same contact information at more than one web site is burdensome.

Alternatively, a consumer may use the traditional yellow pages to locate several businesses and then call each business separately to setup an appointment. However, this approach loses many of the benefits of the web enabled approach. For example, the consumer may not get a hold of someone at each business at the time he decides to place the call. Similarly, the business may attempt to return the consumer's call and find him unavailable.

### BRIEF DESCRIPTION OF THE DRAWINGS

Features and advantages of the disclosed system will be apparent to those of ordinary skill in the art in view of the detailed description of exemplary embodiments which is made with reference to the drawings, a brief description of which is provided below.

FIG. 1 is a high level block diagram of a communications system illustrating an exemplary environment of use for the disclosed system.

FIG. 2 is a more detailed block diagram of an exemplary WAP phone.

FIG. 3 is a more detailed block diagram of an exemplary WAM server.

FIG. 4 is a flowchart of an exemplary advertiser registration process.

FIGS. 5A-5B is a flowchart of an exemplary consumer service request process.

FIG. 6 is a flowchart of an exemplary proxy search process.

FIG. 7 is a more detailed block diagram of another exemplary WAM server.

### DETAILED DESCRIPTION OF EXEMPLARY EMBODIMENTS

In general, the system described herein connects consumers to advertisers using bar-coded yellow page headings and an Internet enabled wireless device which includes a bar-code scanner. Advertisers register with a server by providing information such as which yellow page headings the advertiser is associated with and how the advertiser is to be contacted. Consumers make requests to the server by scanning yellow page bar-code headings (or other selection means) and indicating how the consumer prefers to be contacted. The server then finds matches between consumers and advertisers and facilitates communication between them.

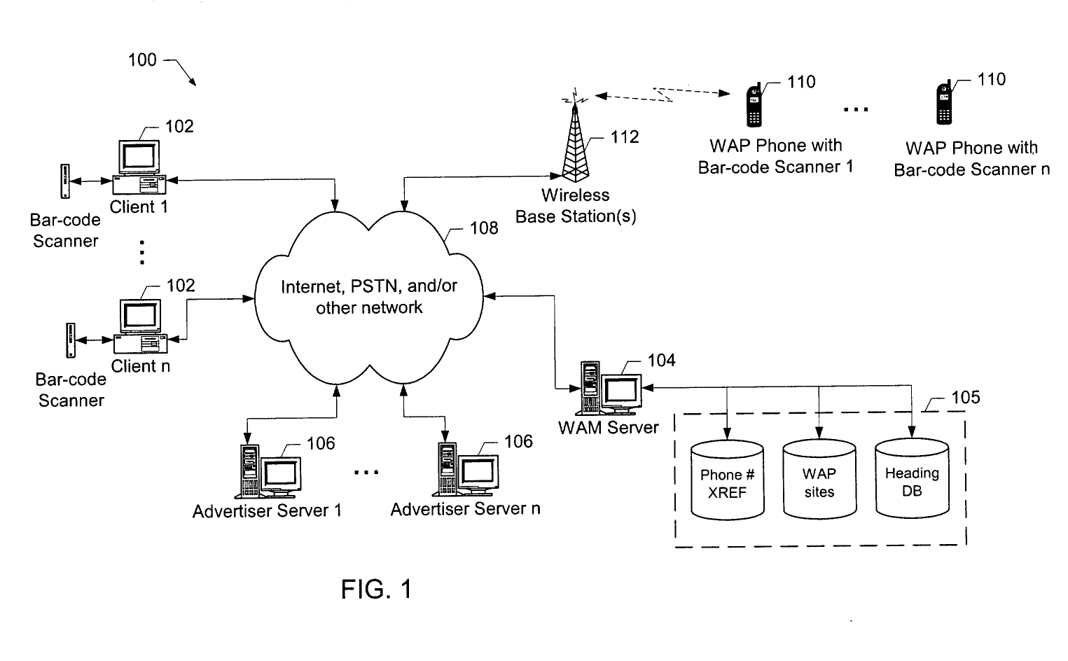

A high level block diagram of an exemplary network communications system 100 is illustrated in FIG. 1. Typically, the system 100 includes one or more client devices 102, one or more wireless advertising management (WAM) servers 104, and one or more advertiser servers 106. Each of these devices may communicate with each other via a connection to a wide area network 108. In some embodiments, the network 108 includes the Internet and/or the public switched telephone network (PSTN). In addition, a plurality of consumers may connect to the network communications system 100 using web enabled wireless telephones 110. For example, a cellular telephone equipped with the Wireless Application Protocol (WAP) standard or any other wireless standard (e.g., iMode) may be used. Preferably, each web enabled wireless telephone 110 connects to the network via a wireless base station 112.

Typically, WAM servers 104 store a plurality of files, programs, and/or web pages for use by the client devices 102, web enabled wireless telephones 110, and/or the advertiser servers 106. In addition, the WAM server stores one or more databases 105 which contain phone number cross references, Wireless Application Protocol (WAP) site addresses, and headings information. One WAM server 104 may handle requests from a large number of other devices. Accordingly, each server 104 is typically a high end computer with a large storage capacity, one or more fast microprocessors, and one or more high speed network connections. Conversely, relative to a typical server 104, each client device 102 and WAP phone 110 typically includes less storage capacity, a single microprocessor, and a single network connection.

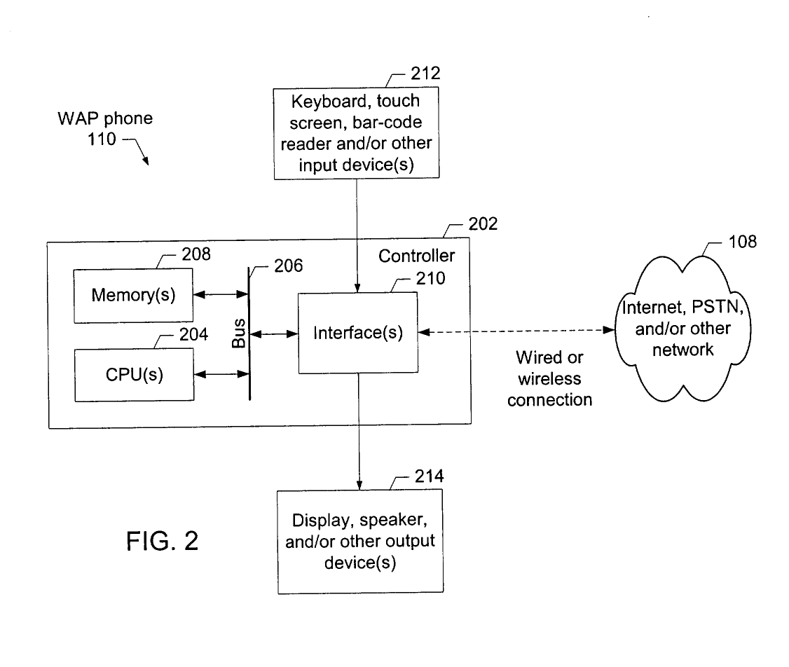

A more detailed block diagram of a WAP phone 110 is illustrated in FIG. 2. A person of ordinary skill in the art will readily appreciate that the functions of the WAP phone 110 may be performed by a personal computer (PC), a personal digital assistant (PDA), an Internet appliance, a cellular telephone, or any other communication device. The WAP phone 110 includes a controller 202 which preferably includes a central processing unit 204 electrically coupled by an address/data bus 206 to a memory device 208 and an interface circuit 210. The CPU 204 may be any type of well known CPU, such as an Intel Pentium™ processor. The memory device 208 preferably includes volatile memory and non-volatile memory. Preferably, the memory device 208 stores a software program that interacts with the communications system 100 as described below. This program may be executed by the CPU 204 in a well known manner. The memory device 208 may also store digital data indicative of documents, files, programs, web pages, etc. retrieved from a server 104, 106 and/or loaded via an input device 212.

The interface circuit 210 may be implemented using any type of well known interface standard, such as an Ethernet interface and/or a Universal Serial Bus (USB) interface. One or more input devices 212 may be connected to the interface circuit 210 for entering data and commands into the controller 202. For example, the input device 212 may be a keyboard, a touch screen, a voice recognition system, and/or a bar-code scanner.

One or more displays, speakers, and/or other output devices 214 may also be connected to the controller 202 via the interface circuit 210. The display 214 may be a liquid crystal displays (LCDs), or any other type of display. The display 214 generates visual displays of data generated during operation of the WAP phone 110. The display 214 is typically used to display WAP pages received from a server 104, 106. The visual displays may include prompts for human operator input, calculated values, detected data, etc.

The WAP phone 110 may also exchange data with other devices via a connection to the network 108. The network connection may wired or wireless. Users of the system 100 may be required to register with a server 104, 106. In such an instance, each user may choose a user identifier and a password which may be required for the activation of services. The user identifier and password may be passed across the Internet 108 using encryption built into the user's browser. Alternatively, the user identifier and/or password may be assigned by the server 104, 106.

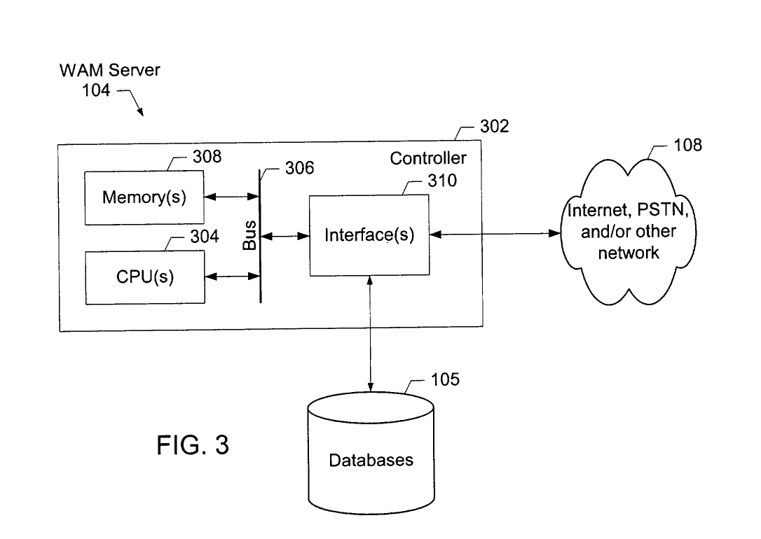

A more detailed block diagram of a WAM server 104 is illustrated in FIG. 3. Like the client device 102, the controller 302 in the server 104 preferably includes a central processing unit 304 electrically coupled by an address/data bus 306 to a memory device 308 and a network interface circuit 310. However, the sever controller 302 is typically more powerful than the client controller 202. Again, the CPU 304 may be any type of well known CPU, such as an Intel Pentium™ processor, and the memory device 308 preferably includes volatile memory and non-volatile memory. Preferably, the memory device 308 stores a software program that implements all or part of the method described below. This program may be executed by the CPU 304 in a well known manner. However, some of the steps described in the method below may be performed manually or without the use of the server 104. The memory device 308 and/or a separate database 314 also store files, programs, web pages, etc. for use by servers 104, 106 and/or the client devices 102.

The server 104 may exchange data with other devices via a connection to the network 108. The network interface circuit 310 may be implemented using any data transceiver, such as an Ethernet transceiver. The network 108 may be any type of network, such as a local area network (LAN) and/or the Internet.

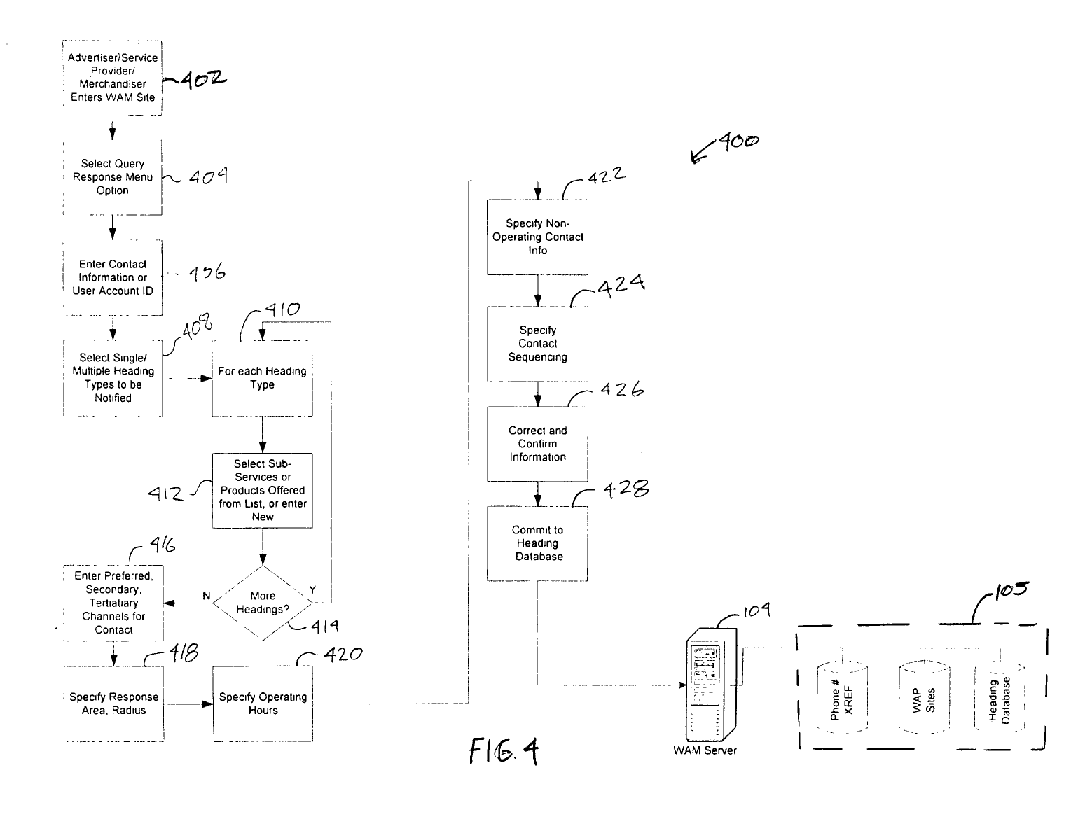

A flowchart of an exemplary advertiser registration process 400 is illustrated in FIG. 4. Portions of the process 400 are embodied in software program(s) which are stored in one or more memory devices and executed by one or more CPUs in a well known manner. However, some or all of the steps of the process 400 may be performed manually. Although the process 400 is described with reference to the flowchart illustrated in FIG. 4, a person of ordinary skill in the art will readily appreciate that many other methods of performing the acts associated with the process 400 may be used. For example, the order of many of the steps may be changed without departing from the scope or spirit of the present invention. In addition, many of the steps described are optional.

Generally, the process 400 causes the WAM server to store advertiser information in the databases 105. Advertiser information includes which yellow page headings the advertiser is associated with and how the advertiser is to be contacted. The advertiser registration process 400 begins when an advertiser connects to the WAM server 104 (step 402) and selects a query response menu option (step 404). Preferably, the advertiser communicates with the WAM server 104 via a client device 102 and/or an advertiser server 106. At the registration web site, the advertiser identifies himself by entering his contact information and/or entering a user account identifier (e.g., user name, telephone, number, and/or password) which is associated with previously entered contact information (step 406).

The advertiser then selects one or more heading types for which he desires notification (step 408). Preferably, the advertiser selects the heading(s) from a list of standard headings (e.g., yellow page headings). For example, if the advertiser is in the heating and air conditioning business, he may select a “heating contractors” heading and/or a “heating equipment and systems” heading.

For each heading (step 410), the advertiser may select subcategories of products and/or services from a predetermined list (step 412). In addition, the advertiser may enter new subcategories which may not be available in the predetermined list (step 412). For example, if the advertiser is in the heating and air conditioning business, he may select and/or enter heating and air conditioning manufacturer's names associated with brands that he services.

When all of the selected headings have been optionally subcategorized (step 414), the advertiser may enter primary, secondary, tertiary, etc. contact channels (step 416). For example, the advertiser may enter a first person's telephone number as the primary contact channel, a second person's telephone number as the secondary contact channel, and an e-mail address as the tertiary contact channel. In addition, the advertiser may specify a service area (step 418) and operating hours (step 420). For example, the advertiser may indicate that his business makes service calls between 9:00 A.M. and 5:00 P.M. in towns A, B, and C. In another example, the advertiser may indicate that his service area extends for a 15 mile radius around a geographical location (e.g., latitude/longitude, address, intersection, etc.) the intersection of Highway 25 and Apple Road. The contact channels may be time dependent and may be modified at any time. For example, the advertiser may specify after-hours contact information (step 422). In addition, the advertiser may specify contact sequencing (step 424). For example, the advertiser may indicate that if no one answers at a first phone number within four rings, to roll the call over to a second phone number.

Once the information is entered, the advertiser may change the information to correct mistakes and/or update old entries (step 426). Subsequently, the information is stored in the databases 105 (step 428).

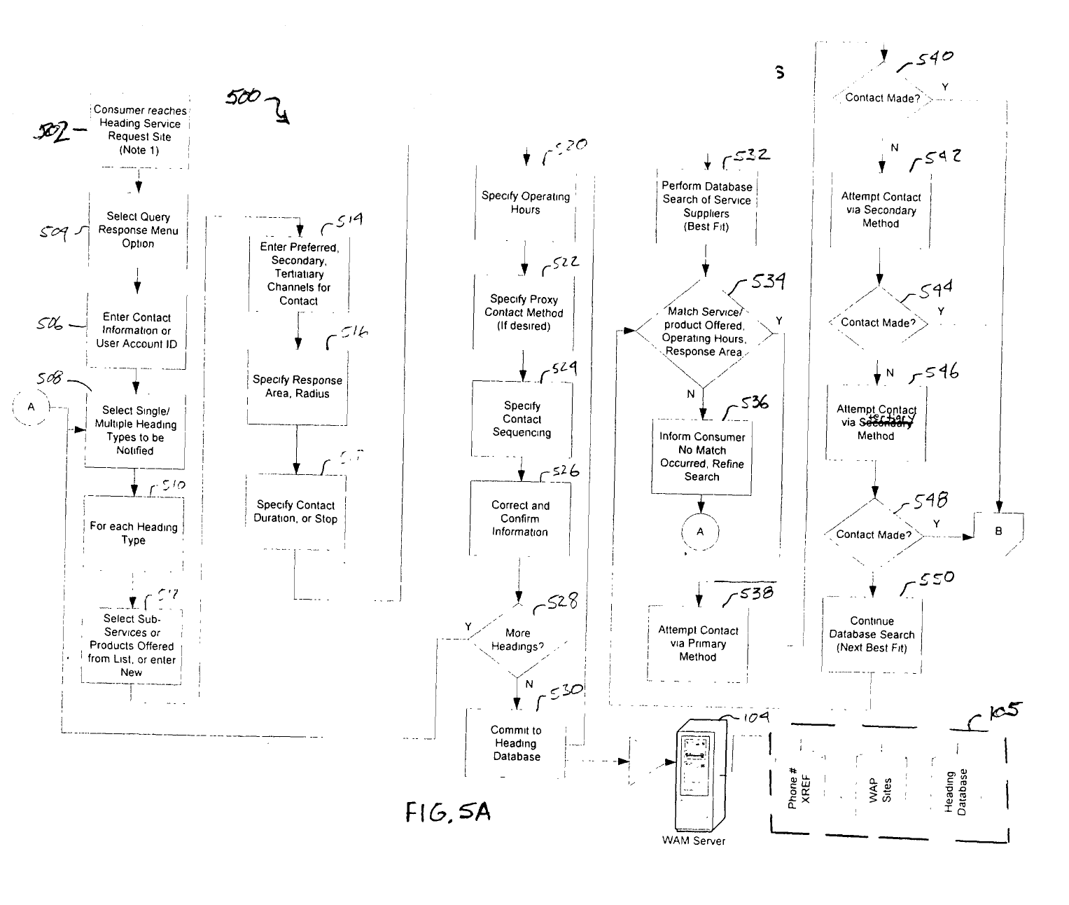

A flowchart of an exemplary consumer service request process 500 is illustrated in FIGS. 5A-5B. Portions of the process 500 are embodied in software program(s) which are stored in one or more memory devices and executed by one or more CPUs in a well known manner. However, some or all of the steps of the process 500 may be performed manually. Although the process 500 is described with reference to the flowchart illustrated in FIG. 5, a person of ordinary skill in the art will readily appreciate that many other methods of performing the acts associated with the process 500 may be used. For example, the order of many of the steps may be changed without departing from the scope or spirit of the present invention. In addition, many of the steps described are optional.

Generally, the process 500 causes the WAM server to store consumer information in the databases 105. Consumer information includes which yellow page bar-code headings the consumer scanned and how the consumer is to be contacted. Alternatively, headings may be entered electronically by entering them manually and/or clicking on a heading button in an electronic directory. The consumer service request process 500 begins when a consumer contacts the WAM server 104 (step 502) and selects a query response menu option (step 504). Preferably, the consumer is located at a client device 102 or a WAP phone 110. Preferably, the consumer identifies himself by entering his contact information or entering a user account identifier which is associated with previously entered contact information (step 506).

The consumer then selects one or more heading types for which he desires notification (step 508). Preferably, the consumer selects the heading(s) by scanning associated bar-codes in a yellow page directory. Alternatively, the consumer may select one or more heading(s) from a list of standard headings provided by a web page. For example, if the consumer is making a request for an air conditioner repair, he may scan or select a “cooling” heading.

For each heading (step 510), the consumer may select subcategories of products and/or services from a predetermined list (step 512). In addition, the consumer may enter new subcategories which may not be available in the predetermined list (step 512). For example, the consumer may select and/or enter the brand name of the manufacture associated with his air conditioner. Other examples of subcategories include color, size, price, availability, etc.

When all of the selected headings have been optionally subcategorized, the consumer may enter primary, secondary, tertiary, etc. contact channels (step 514). For example, the consumer may enter a daytime telephone number as the primary contact channel, an evening telephone number as the secondary contact channel, and an e-mail address as the tertiary contact channel. In addition, the consumer may specify a response area (step 516), a contact duration (step 518), and/or available hours (step 520). For example, the consumer may indicate that he prefers service calls between 11:00 A.M. and 2:00 P.M. from a repair service within 15 miles, and that he does not want solicitations in this matter after Jan. 12, 2002. If the consumer wishes to remain anonymous (e.g., to avoid follow up calls, junk mail, etc.), the consumer may optionally specify proxy contact information (step 522). In addition, the consumer may specify contact sequencing (step 524).

Once the information is entered, the consumer may change the information to correct mistakes and/or update old entries (step 526). If the consumer wishes to make additional requests (step 528), the process preferably repeats from step 508. As the information is entered, the information is preferably stored in the databases 105 (step 530).

Periodically, or in response to a new advertiser or consumer entry in the databases 105, the databases 105 are searched (step 532) in an attempt to match a consumer entry to one or more compatible advertiser entries (step 534). A consumer entry is compatible with an advertiser entry when most or all of the requests in the consumer entry are met by the advertiser entry. For example, the consumer may request a air conditioning repair service under the heading “cooling” and the subcategory “Brand =XYZ.” If an advertiser entry under the heading “cooling” includes the subcategory “Brand =XYZ,” the consumer entry is compatible with the advertiser entry in this example. If an advertiser entry under the heading “cooling” does not include the subcategory “Brand =XYZ,” the consumer entry may not be compatible with the advertiser entry in this example. Of course, any other information included in the consumer entry and the advertiser entry may be compared when determining compatibility. For example, an advertiser's service area may be compared to a consumer's requested response area. Similarly, an advertiser's operating hours may be compared to a consumer's available hours.

If no matches are found, the consumer is informed and invited to refine his search criteria (step 536). If a compatible match is found, the system attempts to contact the advertiser via the primary contact channel specified by the advertiser (step 538). If the primary contact channel fails (step 540), the system attempts to contact the advertiser via the secondary contact channel specified by the advertiser (step 542). If the secondary contact channel fails (step 544), the system attempts to contact the advertiser via the tertiary contact channel specified by the advertiser (step 546). If all attempts to contact the advertiser fail, the database search continues on to the next best fit (step 550).

Once an advertiser is successfully contacted, the service request information entered by the consumer is forwarded to the advertiser (step 552). If the consumer indicated that he wanted to be contacted by proxy (step 554), a response mechanism is provided (step 556) and the proxy data is stored (step 558). For example, the advertiser may send information to the WAM server 104 which forwards the information to the consumer without revealing the consumers contact information to the advertiser. Similarly, the consumer may respond to the advertiser via the server without the server revealing the consumers contact information to the advertiser. Preferably, a proxy identifier is used to keep track of corresponding contact information.

If the consumer did not indicate that he wanted to be contacted by proxy (step 554), the consumers contact information is forwarded to the advertiser (step 560). If the system is preprogrammed to provide an initial response on behalf of the advertiser (step 562), a response mechanism is provided (step 564) and response data is forwarded to the consumer (step 566). For example, a “canned” message provided by the advertiser may be emailed to the consumer.

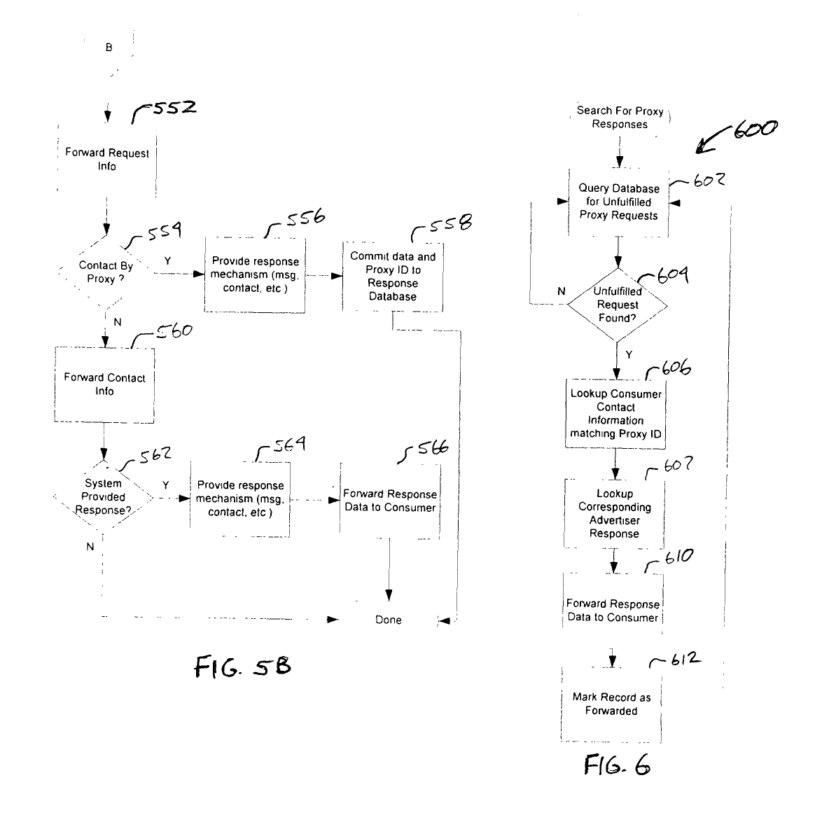

In order to facilitate proxy based messaging, a process 600 to search for proxy responses is provided. A flowchart of an exemplary proxy search process 600 is illustrated in FIG. 6. Portions of the process 600 are embodied in software program(s) which are stored in one or more memory devices and executed by one or more CPUs in a well known manner. However, some or all of the steps of the process 600 may be performed manually. Although the process 600 is described with reference to the flowchart illustrated in FIG. 6, a person of ordinary skill in the art will readily appreciate that many other methods of performing the acts associated with the process 600 may be used. For example, the order of many of the steps may be changed without departing from the scope or spirit of the present invention. In addition, many of the steps described are optional.

The process 600 causes a server to query a database for unfulfilled proxy requests (step 602). If no unfulfilled proxy requests are found (step 604), the process periodically rechecks the database. If an unfulfilled proxy request is found (step 604), the consumer contact information matching the associated proxy identifier (step 606) and the corresponding advertiser response (step 608) are retrieved. The response is then forwarded to the consumer using the consumer contact information (step 610), and the record associated with the request is marked as forwarded (step 612).

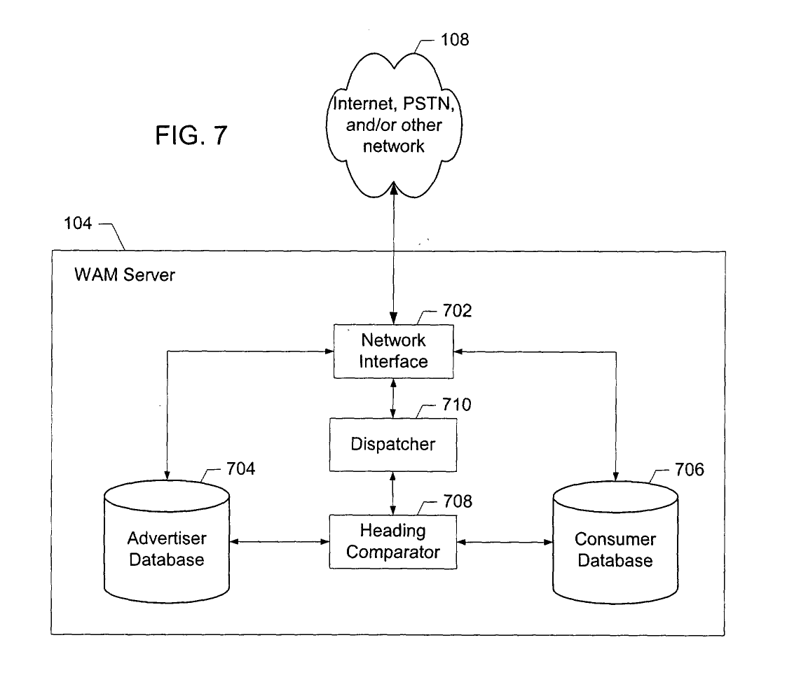

A more detailed block diagram of another embodiment of the WAM server 104 is illustrated in FIG. 7. In this embodiment, the WAM server 104 includes a plurality of interconnected modules 702-710. Each of the modules may be implemented by a microprocessor executing software instructions and/or conventional electronic circuitry. In addition, a person of ordinary skill in the art will readily appreciate that certain modules may be combined or divided according to customary design constraints.

For the purpose of receiving consumer information and advertiser information including yellow page headings, contact channel information, contact sequencing data, subcategories, time dependency data, service area information, response area information, operating hours, available hours, proxy requests, and other data, the WAM server 104 includes a network interface 702. In addition, the network interface 702 is preferably structured to transmit at least a portion of the consumer information, at least a portion of the advertiser information, and other data to other device connected to the network 108. For example, the network interface 702 may transmit consumer information to a consumer for editing, advertiser information to an advertiser for editing, consumer information to an advertiser when a match is found, and/or advertiser information to a consumer when a match is found. The network interface 702 is operatively coupled to the network 108 in a well know manner. For example, the network interface 702 may be an Ethernet interface circuit electrically coupled to the Internet via an Ethernet cable.

For the purpose of storing the advertiser information, the WAM server 104 includes a advertiser database 704. The advertiser database 704 is operatively coupled to the network interface 702. Information in the advertiser database 704 is preferably updated by authorized advertisers. In one embodiment, advertisers pay a fee to be authorized. Once authorized, the advertiser is given (or the advertiser provides) a user name and password to gain access to information associated with his/her business. Of course, one advertiser may not modify another advertiser's information or a consumer's information without authorization.

For the purpose of storing the consumer information, the WAM server 104 includes a consumer database 706. The consumer database 706 is operatively coupled to the network interface 702. Information in the consumer database 706 is preferably updated by authorized consumers. In one embodiment, consumers pay a fee to be authorized. In another embodiment, consumers may be asked to provide certain demographic information to be authorized. In yet another embodiment, consumers must merely provide a contact channel to be authorized. Once authorized, the consumer is given (or the consumer provides) a user name and password to gain access to information associated with his/her product/service requests. Of course, one consumer may not modify another consumer's information or an advertiser's information without authorization.

For the purpose of comparing advertiser listed yellow page headings with consumer selected yellow page headings, the WAM server 104 includes a heading comparator 708. The heading comparator 708 is operatively coupled to the advertiser database 704 and the consumer database 706. The heading comparator 708 may determine when an advertiser listed yellow page heading matches a consumer selected yellow page heading by comparing the headings (or a code representing the headings) in a well known manner. In addition, sub-categories may be compared when attempting to match up a advertiser with a consumer.

For the purpose of communicating consumer information to the advertiser and/or advertiser information to the consumer via a predefined contact channel, the WAM server 104 includes a dispatcher 710. The dispatcher 710 is operatively coupled to the heading comparator 708 and the network interface 702. The dispatcher 710 selects a contact channel based on a predefined contact sequencing data and/or time dependency data. The dispatcher 710 may generate e-mail messages, web pages, voice messages, and/or any other type of message.

In summary, persons of ordinary skill in the art will readily appreciate that a method and apparatus for connecting consumers to advertisers using bar-coded yellow page headings has been provided. Using the teaching described herein, a consumer may schedule communications with an advertiser using a web enabled wireless telephone and bar-coded yellow pages without an excessive need to enter keywords, select hyperlinks, read web pages, or fill out forms.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description, but rather by the claims appended hereto.

What is claimed is:

1. A method of connecting a consumer to an advertiser, the method comprising the steps of:
storing advertiser information in a first database, the advertiser information including a first yellow page heading and a first contact channel, the first yellow page heading being selected from a plurality of predetermined yellow page headings, the first contact channel including at least one of a telephone number associated with the advertiser and an e-mail address associated with the advertiser;
storing consumer information in a second database, the consumer information including a second yellow page heading and a second contact channel, the second yellow page heading being determined by scanning a machine readable symbol indicative of the second yellow page heading, the second contact channel including at least one of a telephone number associated with the consumer and an e-mail address associated with the consumer;
determining that the advertiser information is compatible with the consumer information; and
communicating at least a portion of the consumer information to the advertiser via the first contact channel.

2. A method as defined in claim 1, further comprising the step of communicating at least a portion of the advertiser information to the consumer via the second contact channel.

3. A method as defined in claim 1, further comprising the step of communicating a predetermined message to the consumer via the second contact channel.

4. A method as defined in claim 1, wherein the step of storing advertiser information in a first database comprises the step of storing a third contact channel associated with the advertiser and advertiser contact sequencing data, the advertiser contact sequencing data being indicative of a precedence order for the first contact channel and the third contact channel.

5. A method as defined in claim 1, wherein the step of storing consumer information in a second database comprises the step of storing a third contact channel associated with the consumer and consumer contact sequencing data, the consumer contact sequencing data being indicative of a precedence order for the second contact channel and the third contact channel.

6. A method as defined in claim 5, wherein the step of storing advertiser information in a first database comprises the step of storing a fourth contact channel associated with the advertiser and advertiser contact sequencing data, the advertiser contact sequencing data being indicative of a precedence order for the first contact channel and the fourth contact channel.

7. A method as defined in claim 1, wherein the step of storing advertiser information in a first database comprises the step of storing a third contact channel associated with the advertiser and time dependency data, the time dependency data being indicative of a first time frame during which the first contact channel should be used and a second time frame during which the third contact channel should be used, the first time frame being different than the second time frame.

8. A method as defined in claim 1, wherein the step of storing consumer information in a second database comprises the step of storing a third contact channel associated with the consumer and time dependency data, the time dependency data being indicative of a first time frame during which the second contact channel should be used and a second time frame during which the third contact channel should be used, the second time frame being different than the third time frame.

9. A method as defined in claim 1, wherein the step of storing advertiser information in a first database comprises the step of storing a subcategory, the subcategory further specifying a product/service under the first yellow page heading.

10. A method as defined in claim 9, wherein the subcategory is a brand name.

11. A method as defined in claim 9, wherein the subcategory is a color.

12. A method as defined in claim 9, wherein the subcategory is a size.

13. A method as defined in claim 9, wherein the subcategory is a price.

14. A method as defined in claim 9, wherein the subcategory is an availability.

15. A method as defined in claim 1, wherein the step of storing consumer information in a second database comprises the step of storing a subcategory, the subcategory further specifying a product/service under the second yellow page heading.

16. A method as defined in claim 15, wherein the subcategory is a brand name.

17. A method as defined in claim 1, wherein the step of storing advertiser information in a first database comprises the step of storing service area information.

18. A method as defined in claim 1, wherein the step of storing consumer information in a second database comprises the step of storing response area information.

19. A method as defined in claim 1, wherein the step of storing advertiser information in a first database comprises the step of storing operating hours.

20. A method as defined in claim 1, wherein the step of storing consumer information in a second database comprises the step of storing available hours.

21. A method as defined in claim 1, wherein the step of storing consumer information in a second database comprises the step of storing a proxy request, the proxy request being indicative of a desire to remain anonymous.

22. A method as defined in claim 1, further comprising the step of receiving the advertiser information via the Internet.

23. A method as defined in claim 1, further comprising the step of receiving the consumer information via the Internet.

24. A method as defined in claim 1, wherein the first database comprises the second database.

25. A method of connecting a consumer to an advertiser using bar-coded yellow page headings, the method comprising the steps of:
storing advertiser information in a first database, the advertiser information including a first yellow page heading, a first contact channel, a second contact channel, advertiser contact sequencing data, and a first subcategory, the first yellow page heading being selected from a plurality of predetermined yellow page headings, the first contact channel including at least one of a telephone number associated with the advertiser and an e-mail address associated with the advertiser, the second contact channel including at least one of a telephone number associated with the advertiser and an email address associated with the advertiser, the advertiser contact sequencing data being indicative of a precedence order for the first contact channel and the second contact channel, the first subcategory further specifying a product/service under the first yellow page heading;
storing consumer information in a second database, the consumer information including a second yellow page heading, a third contact channel, a fourth contact channel, consumer contact sequencing data, time dependency data, and a second subcategory, the second yellow page heading being determined by scanning a machine readable symbol indicative of the second yellow page heading, the third contact channel including at least one of a telephone number associated with the consumer and an e-mail address associated with the consumer, the fourth contact channel including at least one of a telephone number associated with the consumer and an e-mail address associated with the consumer, the consumer contact sequencing data being indicative of a precedence order for the third contact channel and the fourth contact channel, the time dependency data being indicative of a first time frame during which the third contact channel should be used and a second time frame during which the fourth contact channel should be used, the second time frame being different than the third time frame, the second subcategory further specifying a product/service under the second yellow page heading;
determining that the advertiser information is compatible with the consumer information;
communicating at least a portion of the consumer information to the advertiser via the first contact channel; and
communicating at least a portion of the advertiser information to the consumer via the second contact channel.

26. An apparatus for connecting a consumer to an advertiser, the apparatus comprising:
a network interface circuit;
an advertiser database;
a consumer database;
a processing unit operatively coupled to the network interface circuit, the advertiser database, and the consumer database; and
a memory device operatively coupled to the processing unit, the memory device storing a software program capable of being executed by the processing unit, the software program being structured to cause the processing unit to:
receive advertiser information from the network interface circuit;
determine a first yellow page heading and a first contact channel from the advertiser information, the first yellow page heading being previously selected from a plurality of predetermined yellow page headings, the first contact channel including at least one of a telephone number associated with the advertiser and an e-mail address associated with the advertiser;
store at least a first portion of the advertiser information in the advertiser database;
receive consumer information from the network interface circuit;
determine a second yellow page heading and a second contact channel from the consumer information, the second yellow page heading being previously selected by scanning a machine readable symbol indicative of the second yellow page heading, the second contact channel including at least one of a telephone number associated with the consumer and an e-mail address associated with the consumer;
store at least a first portion of the consumer information in the consumer database;
determine that the advertiser information is compatible with the consumer information; and
transmit at least a second portion of the consumer information to the advertiser via the first contact channel using the network interface circuit.

27. An apparatus as defined in claim 26, wherein the advertiser database comprises the consumer database.

28. An apparatus as defined in claim 26, wherein the software program is further structured to cause the processing unit to transmit the second portion of the consumer information to the advertiser via a plurality of contact channels including the first contact channel in a sequence defined by the advertiser.

29. An apparatus as defined in claim 28, wherein the first portion of the consumer information comprises the second portion of the consumer information.

30. An apparatus as defined in claim 26, wherein the software program is further structured to cause the processing unit to transmit at least a second portion of the advertiser information to the consumer via a plurality of contact channels including the second contact channel in a sequence defined by the consumer.

31. An apparatus as defined in claim 30, wherein the first portion of the advertiser information comprises the second portion of the advertiser information.

32. An apparatus for connecting a consumer to an advertiser, the apparatus comprising:
an advertiser database storing advertiser information, the advertiser information including a first yellow page heading and a first contact channel, the first yellow page heading being previously selected from a plurality of predetermined yellow page headings, the first contact channel including at least one of a telephone number associated with the advertiser and an e-mail address associated with the advertiser;
a consumer database storing consumer information, the consumer information including a second yellow page heading and a second contact channel, the second yellow page heading being previously selected by scanning a machine readable symbol indicative of the second yellow page heading, the second contact channel including at least one of a telephone number associated with the consumer and an e-mail address associated with the consumer;
a heading comparator operatively coupled to the advertiser database and the consumer database, the heading comparator being structured to compare the first yellow page heading and the second yellow page heading;
a network interface circuit; and
a dispatcher operatively coupled to the heading comparator and the network interface, the dispatcher being structured to communicate at least a portion of the consumer information to the advertiser via the first contact channel.

33. An apparatus as defined in claim 32, wherein the dispatcher is further structured to attempt communication of at least a portion of the advertiser information to the consumer via a plurality of contact channels including the second contact channel in a sequence defined by the consumer.

34. An apparatus as defined in claim 33, wherein the dispatcher is further structured to select the plurality of contact channels based in part on time dependency data and a current time of day.

35. An apparatus as defined in claim 32, wherein the dispatcher is further structured to attempt communication of the at least a portion of the consumer information to the advertiser via a plurality of contact channels in a sequence defined by the advertiser.

36. A method of connecting a consumer to an advertiser, the method comprising the steps of:
storing advertiser information in a first database, the advertiser information including a first yellow page heading and a first contact channel, the first yellow page heading being selected from a plurality of predetermined yellow page headings, the first contact channel including at least one of a telephone number associated with the advertiser and an e-mail address associated with the advertiser;
storing consumer information in a second database, the consumer information including a second yellow page heading and a second contact channel, the second yellow page heading being determined by receiving a selection in an electronic directory, the selection being indicative of the second yellow page heading, the second contact channel including at least one of a telephone number associated with the consumer and an e-mail address associated with the consumer;
determining that the advertiser information is compatible with the consumer information; and
communicating at least a portion of the consumer information to the advertiser via the first contact channel.

37. An apparatus for connecting a consumer to an advertiser, the apparatus comprising:
an advertiser database storing advertiser information, the advertiser information including a first yellow page heading and a first contact channel, the first yellow page heading being previously selected from a plurality of predetermined yellow page headings, the first contact channel including at least one of a telephone number associated with the advertiser and an e-mail address associated with the advertiser;
a consumer database storing consumer information, the consumer information including a second yellow page heading and a second contact channel, the second contact channel including at least one of a telephone number associated with the consumer and an e-mail address associated with the consumer;
a heading comparator operatively coupled to the advertiser database and the consumer database, the heading comparator being structured to compare the first yellow page heading and the second yellow page heading;
a network interface circuit; and
a dispatcher operatively coupled to the heading comparator and the network interface, the dispatcher being structured to communicate at least a portion of the consumer information to the advertiser via the first contact channel.
